(19) United States
(12) Patent Application Publication
(10) Pub. No.: US 2007/0157043 A1
(43) Pub. Date: Jul. 5, 2007

(54) Portable electronic device with a power saving function and method of saving power for the portable electronic device

(76) Inventors: Young-Fei Chien, Hsinchu (TW); Te-Yu Kao, Hsinchu (TW); Chin-Hua Chou, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/378,431

(22) Filed: Mar. 20, 2006

(30) Foreign Application Priority Data
Dec. 30, 2005 (TW) 94147791

(51) Int. Cl. G06F 1/32

(52) U.S. Cl. 713/320

(57) ABSTRACT

A portable electronic device with a power saving function includes a portable electronic system, a DSC (Digital Still Camera) system, and a transmission interface. The portable electronic system has a first process unit, the DSC system has a second process unit, and the transmission interface is electrically connected between the first process unit of the portable electronic system and the second process unit of the DSC system. Whereby, when using the DSC system, the portable electronic system gets into a power saving mode, and when needing to use the portable electronic system, the DSC system outputs a trigger signal to the portable electronic system via the transmission interface to wake the portable electronic system up.

### BACKGROUND OF THE INVENTION

1. Field of the Invention

The present invention relates to a portable electronic device with a power saving function and a method of saving power for the portable electronic device, and particularly relates to a DSC system that allows a portable electronic system (such as a mobile phone system, a PDA system or a PDA phone system) that is electrically connected with the DSC system to change into a power saving mode.

2. Description of the Related Art

With the coming of the age of information technology, and the improvement of the Internet and communication techniques, cell phones (or mobile phones) have become one of the most common communication tools. Cell phone products are loved and utilized by many consumers for their small size, lightweight, portability, numerous functions, and low price. People can send messages to their friends, family or business associates immediately via their cell phone. As such, cell phones are more convenient and faster than traditional landline telephones. Cell phone users regularly receive and send information via wireless communication and can use text messages and emails to achieve this function.

Referring to FIG. 1, known mobile phones include a mobile phone system 1a, and a DSC (Digital Still Camera) system 2a. Moreover, the mobile phone system 1a and the DSC system 2a can transmit commands or data to each other via a clock transmission line 30a and a data transmission line 31a or other data buses.

However, even if either the mobile phone system 1a or the DSC system 2a are not operating at the time, the mobile phone system 1a, or the DSC system 2a need to continuously, or at predetermined time intervals, detect the other device. Hence, the mobile phone system 1a or the DSC system 2a cannot get into a power saving mode by itself, and the power consumption of the mobile phone cannot be saved.

### SUMMARY OF THE INVENTION

The present invention provides a portable electronic device with a power saving function and a method of saving power for the portable electronic device. When a DSC system is in use, a portable electronic system (such as a mobile phone system, a PDA system or a PDA phone system) that is electrically connected with the DSC system can get into a power saving mode via a transmission interface that is electrically connected between the portable electronic system and the DSC system.

Moreover, when a user wants to use the portable electronic system to perform relevant processes, the user can control the DSC system to output a trigger signal to the portable electronic system via the transmission interface to wake the portable electronic system up.

A first aspect of the present invention is a portable electronic device with a power saving function, comprising a portable electronic system, a DSC (Digital Still Camera) system, and a transmission interface. The portable electronic system has a first process unit, the DSC system has a second process unit, and the transmission interface is electrically connected between the first process unit of the portable electronic system and the second process unit of the DSC system. Whereby, when using the DSC system, the portable electronic system gets into a power saving mode, and when it needs to use the portable electronic system, the DSC system outputs a trigger signal to the portable electronic system via the transmission interface to wake the portable electronic system up.

A second aspect of the present invention is a method of saving power for a portable electronic device, comprising: turning on a portable electronic system that has a first process unit to use the portable electronic system; turning on a DSC (Digital Still Camera) system that has a second process unit, and switching the portable electronic system into a power saving mode at the same time; outputting a trigger signal from the DSC system to the portable electronic system via a transmission interface electrically connected between the first process unit of the portable electronic system and the second process unit of the DSC system to wake the portable electronic system up.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawings, in which:

FIG. 1 is a function block diagram of a mobile phone according to a prior art;

FIG. 2 is a function block diagram of a portable electronic device with a power saving function according to the present invention; and

FIG. 3 is a flowchart of a method of saving power for a portable electronic device according to the present invention.

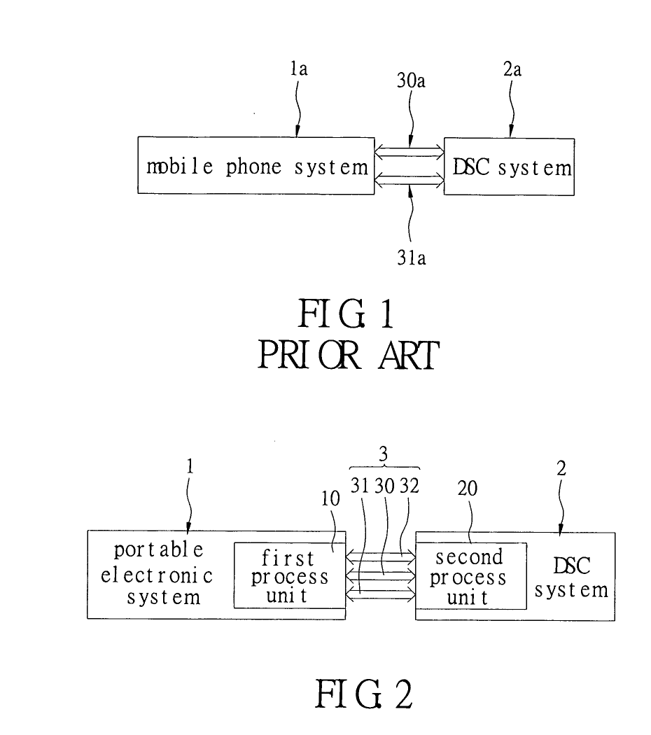

### DETAILED DESCRIPTION OF PREFERRED EMBODIMENTS

Referring to FIG. 2, the present invention provides a portable electronic device with a power saving function. The portable electronic comprises a portable electronic system 1, a DSC (Digital Still Camera) 2, and a transmission interface 3.

The portable electronic system 1 has a first process unit 10, the DSC system 2 has a second process unit 20, and the transmission interface 3 is electrically connected between the first process unit 10 of the portable electronic system 1 and the second process unit 20 of the DSC system 2. In addition, the transmission interface 3 is comprised of at least a clock transmission line 30, a data transmission line 31 and an interruption line 32.

Moreover, according to different demands, the portable electronic system 1 can be a mobile phone system, a PDA phone system, or a PDA system. In addition, both the first process unit 10 and the second process unit 20 can be a baseband CUP, a media processor, or an application processor. Furthermore, the portable electronic system 1 can be an I²C (Inter-Integrated Circuit) bus or any type of transmission line.

Whereby, when a user uses the DSC system 2, the portable electronic system 1 gets into a power saving mode, and when the user needs to use the portable electronic system 1, the DSC system 2 outputs a trigger signal to the portable electronic system 1 via the transmission interface 3 to wake the portable electronic system 1 up. Hence, because the present invention adds the interruption line 32, not only is communication between the portable electronic system 1 and the DSC system 2 more convenient, but also the DSC system 2 can output the trigger signal to the portable electronic system 1 via the transmission interface 3 to wake the portable electronic system 1 up to perform necessary processes to save power.

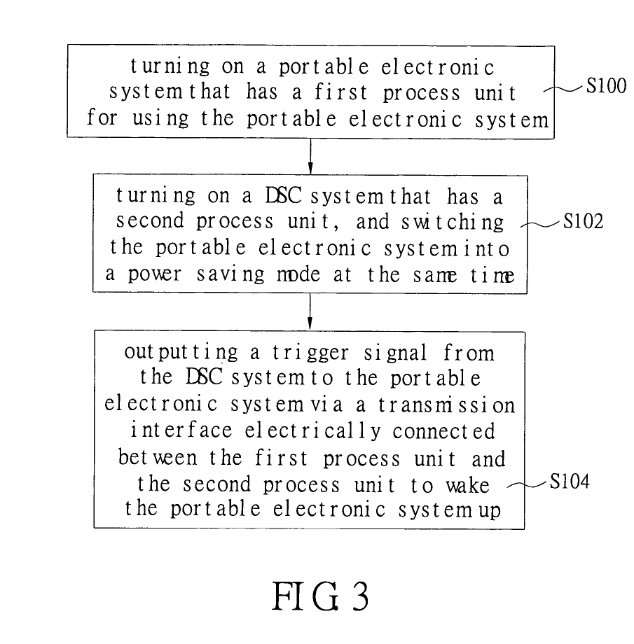

Referring to FIG. 3, the present invention provides a method of saving power for a portable electronic device. The method comprises: firstly, turning on a portable electronic system 1 that has a first process unit 10 for using the portable electronic system 1 (S100); next, turning on a DSC (Digital Still Camera) system 2 that has a second process unit 20, and switching the portable electronic system 1 into a power saving mode (the portable electronic system's power saving mode) at the same time (S102); finally, outputting a trigger signal from the DSC system 2 to the portable electronic system 1 via a transmission interface 3 that is electrically connected between the first process unit 10 and the second process unit 20 to wake the portable electronic system 1 up (S104). Moreover, after waking the portable electronic system 1 up, the method further comprises: switching the DSC system 2 into a power saving mode (the DSC system's power saving mode) or a closed status.

In conclusion, when the DSC system 2 is in use, the portable electronic system 1 (such as a mobile phone system, a PDA system, or a PDA phone system) that is electrically connected with the DSC system 2 can switch into a power saving mode via the transmission interface 3 that is electrically connected between the portable electronic system 1 and the DSC system 2. Moreover, when a user wants to use the portable electronic system 1 to perform relevant processes, the user can control the DSC system 2 to output a trigger signal to the portable electronic system 1 via the transmission interface 3 to wake the portable electronic system 1 up.

Although the present invention has been described with reference to the preferred best molds thereof, it will be understood that the invention is not limited to the details thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A portable electronic device with a power saving function, comprising:
a portable electronic system having a first process unit;
a DSC (Digital Still Camera) system having a second process unit; and
a transmission interface electrically connected between the first process unit of the portable electronic system and the second process unit of the DSC system;
whereby, when using the DSC system, the portable electronic system switches into a power saving mode, and when needing to use the portable electronic system, the DSC system outputs a trigger signal to the portable electronic system via the transmission interface to wake the portable electronic system up.

2. The portable electronic device as claimed in claim 1, wherein the portable electronic system is a mobile phone system.

3. The portable electronic device as claimed in claim 1, wherein the portable electronic system is a PDA phone system.

4. The portable electronic device as claimed in claim 1, wherein the portable electronic system is a PDA system.

5. The portable electronic device as claimed in claim 1, wherein the first process unit is a baseband CUP, a media processor, or an application processor, and the second process unit is a baseband CUP, a media processor, or an application processor.

6. The portable electronic device as claimed in claim 1, wherein the transmission interface is an I²C (Inter-Integrated Circuit) bus.

7. The portable electronic device as claimed in claim 1, wherein the transmission interface comprises at least a clock transmission line, a data transmission line, and an interruption line.

8. The portable electronic device as claimed in claim 7, wherein the trigger signal is transmitted from the DSC system to the portable electronic system via the interruption line to wake the portable electronic system up.

9. A method of saving power for a portable electronic device, comprising:
turning on a portable electronic system that has a first process unit for using the portable electronic system;
turning on a DSC (Digital Still Camera) system that has a second process unit, and making the portable electronic system into a power saving mode at the same time;
outputting a trigger signal from the DSC system to the portable electronic system via a transmission interface electrically connected between the first process unit of the portable electronic system and the second process unit of the DSC system to wake the portable electronic system up.

10. The method as claimed in claim 9, wherein the portable electronic system is a mobile phone system.

11. The method as claimed in claim 9, wherein the portable electronic system is a PDA phone system.

12. The method as claimed in claim 9, wherein the portable electronic system is a PDA system.

13. The method as claimed in claim 9, wherein the first process unit is a baseband CUP, a media processor, or an application processor, and the second process unit is a baseband CUP, a media processor, or an application processor.

14. The method as claimed in claim 9, wherein the transmission interface is an I²C (Inter-Integrated Circuit) bus.

15. The portable electronic device as claimed in claim 9, wherein the transmission interface comprises at least a clock transmission line, a data transmission line, and an interruption line.

16. The portable electronic device as claimed in claim 15, wherein the trigger signal is transmitted from the DSC system to the portable electronic system via the interruption line to wake the portable electronic system up.

17. The portable electronic device as claimed in claim 9, wherein after waking the portable electronic system up, the DSC system switches into a power saving mode or a closed status.
